(19) United States
(12) Patent Application Publication
(10) Pub. No.: US 2025/0297980 A1
(43) Pub. Date: Sep. 25, 2025

(54) GAS SENSOR

(71) Applicant: TDK Corporation, Tokyo (JP)

(72) Inventor: Yoshikatsu TANAKA, Tokyo (JP)

(21) Appl. No.: 19/071,890

(22) Filed: Mar. 6, 2025

(30) Foreign Application Priority Data
Mar. 22, 2024 (JP) 2024-046262
Nov. 22, 2024 (JP) 2024-203813

(51) Int. Cl. G01N 27/18

(52) U.S. Cl. CPC G01N 27/18

(57) ABSTRACT

Disclosed herein is a gas sensor that includes a first sensor part configured to output a first detection signal, a second sensor part configured to output a second detection signal, and a signal processing circuit configured to control the first and second sensor parts and calculate a concentration of a gas to be detected based on the first and second detection signals. The signal processing circuit is configured to alternately repeatedly execute a first gas concentration measurement operation and a first dummy heating operation when controlling the first sensor part. The signal processing circuit is configured to repeatedly execute a second gas concentration measurement operation without executing a dummy heating operation when controlling the second sensor part. An execution frequency of the second gas concentration measurement operation is higher than an execution frequency of the first gas concentration measurement operation in a first operation period.

### CROSS-REFERENCE TO RELATED APPLICATION

This application claims the benefit of Japanese Patent Application No. 2024-046262, filed on Mar. 22, 2024, and Japanese Patent Application No. 2024-203813, filed on Nov. 22, 2024, the entire disclosures of which are incorporated by reference herein.

### BACKGROUND OF THE ART

### Field of the Art

The present disclosure relates to a gas sensor and, more particularly, to a gas sensor that measures the concentration of a gas to be detected by heating a temperature-sensitive element such as a thermistor.

### Description of Related Art

International Publication WO 2020/031517 discloses a gas sensor that measures the concentration of a gas to be detected by heating a thermistor for detection and a thermistor for reference to different temperatures. In this gas sensor, a dummy heating period is provided after measurement operation in a measurement period, where a heating temperature for the detection thermistor in the measurement period and a heating temperature for the reference thermistor in the dummy heating period are made to coincide with each other, and a heating temperature for the reference thermistor in the measurement period and a heating temperature for the detection thermistor in the dummy heating period are made to coincide with each other, thus reducing a difference in thermal history between the detection thermistor and the reference thermistor.

However, providing the dummy heating period prolongs a measurement period, so that when the concentration of a gas to be detected significantly varies in a short time, a measurement result may fail to follow the concentration variation.

### SUMMARY

A gas sensor according an aspect of the present disclosure includes: a first sensor part including first and second temperature-sensitive elements connected in series, a first heater configured to heat the first temperature-sensitive element, and a second heater configured to heat the second temperature-sensitive element, wherein the first sensor part is configured to output a first detection signal from a node between the first and second temperature-sensitive elements; a second sensor part including third and fourth temperature-sensitive elements connected in series, a third heater configured to heat the third temperature-sensitive element, and a fourth heater configured to heat the fourth temperature-sensitive element, wherein the second sensor part is configured to output a second detection signal from a node between the third and fourth temperature-sensitive elements; and a signal processing circuit configured to control the first and second sensor parts and calculate a concentration of a gas to be detected based on the first and second detection signals. The signal processing circuit is configured to: when controlling the first sensor part, alternately repeatedly execute a first gas concentration measurement operation of heating the first temperature-sensitive element to a first temperature range using the first heater and heating the second temperature-sensitive element to a second temperature range using the second heater and a first dummy heating operation of heating the first temperature-sensitive element to the second temperature range using the first heater and heating the second temperature-sensitive element to the first temperature range using the second heater; and when controlling the second sensor part, repeatedly execute a second gas concentration measurement operation of heating the third temperature-sensitive element to the first temperature range using the third heater and heating the fourth temperature-sensitive element to the second temperature range using the fourth heater without executing an operation of heating the third temperature-sensitive element to the second temperature range using the third heater and heating the fourth temperature-sensitive element to the first temperature range using the fourth heater. An execution frequency of the second gas concentration measurement operation is higher than an execution frequency of the first gas concentration measurement operation in a first operation period.

### BRIEF DESCRIPTION OF THE DRAWINGS

The above features and advantages of the present disclosure will be more apparent from the following description of some embodiments taken in conjunction with the accompanying drawings, in which:

FIG. 1 is a circuit diagram illustrating the configuration of a gas sensor 100 according to an embodiment of the technology described herein;

FIGS. 2A and 2B are schematic views for explaining an example of the gas concentration measurement operation of the sensor parts 10 and 20;

FIG. 3 is a flowchart for explaining the operation of the sensor part 10;

FIG. 4 is a timing chart for explaining the operation of the sensor part 10;

FIG. 5 is a graph illustrating the relationship between the ratio (Toff2/Ton2) of the OFF period Toff2 to the ON period Ton2 and a drift amount per unit time of the measurement result of CO₂ gas concentration;

FIG. 6 is a graph illustrating a change in the output signal Vout in an atmosphere where CO₂ gas concentration is controlled;

FIG. 7 is a timing chart for explaining the operation of the sensor part 10 according to a modification;

FIG. 8 is a flowchart for explaining the operation of the sensor part 20;

FIG. 9 is a timing chart for explaining the operation of the sensor part 20;

FIG. 10 is a timing chart for explaining the operations of the sensor parts 10 and 20 in the operation period T1;

FIG. 11 is a timing chart for explaining how the gas concentration measurement operation using the sensor unit 20 is intermittently performed;

FIG. 12 is a flowchart for explaining the operation of the sensor part 20 according to a modification;

FIG. 13 is a timing chart for explaining an example of the operation of the sensor part 20 according to a modification; and

FIG. 14 is a timing chart for explaining another example of the operation of the sensor part 20 according to a modification.

### DETAILED DESCRIPTION OF THE EMBODIMENTS

The present disclosure relates to a gas sensor that measures the concentration of a gas to be detected by heating a temperature-sensitive element such as a thermistor and describes a technology for making a measurement result follow a variation in the concentration of a gas to be detected even when the concentration of a gas to be detected significantly varies in a short time.

Some embodiments of the present disclosure will be explained below in detail with reference to the accompanying drawings.

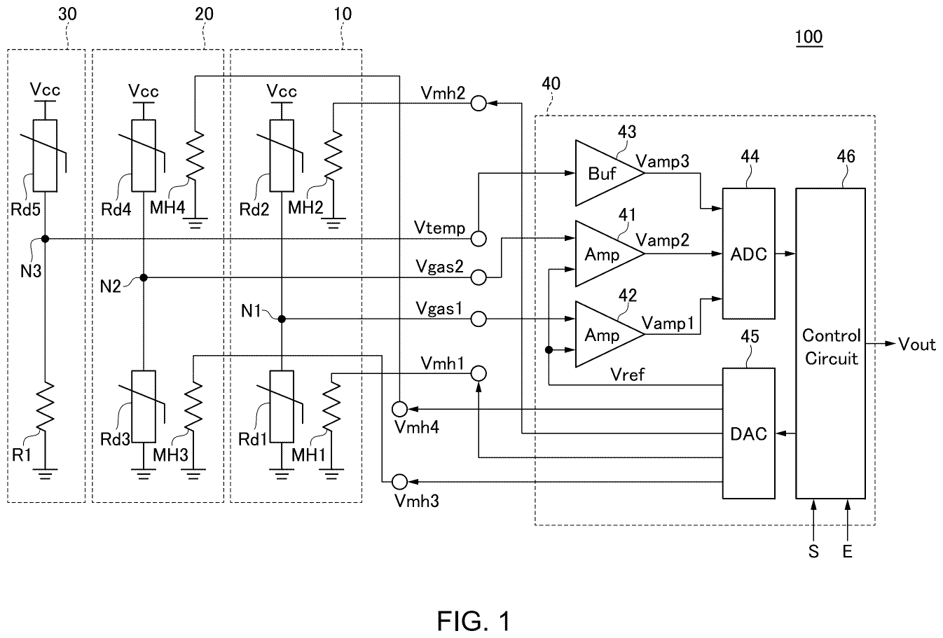

FIG. 1 is a circuit diagram illustrating the configuration of a gas sensor 100 according to an embodiment of the technology described herein.

As described in FIG. 1, the gas sensor 100 according to the present embodiment includes two sensor parts 10 and 20 for detecting the concentration of a gas to be detected, a temperature sensor 30, and a signal processing circuit 40. Although not particularly limited, the gas sensor 100 according to the present embodiment is a heat-conduction type gas sensor for detecting the concentration of CO₂ gas in measurement atmosphere.

The sensor part 10 includes thermistors Rd2 and Rd1 connected in series in this order between a power supply Vcc and a ground GND and heaters MH1 and MH2 for heating the thermistors Rd1 and Rd2, respectively. A detection signal Vgas1 of the sensor part 10 appears at a node N1 between the thermistors Rd1 and Rd2. The thermistor Rd2 is a temperature-sensitive element for detection, and the thermistor Rd1 is a temperature-sensitive element for reference. The thermistors Rd1 and Rd2 are each a resistor whose resistance value varies with temperature. Examples of the material of the thermistors Rd1 and Rd2 and thermistors Rd3, Rd4, and Rd5 to be described later include vanadium oxide, amorphous silicon, polycrystalline silicon, an oxide with a spinel crystal structure containing manganese, titanium oxide, and yttrium-barium-copper oxide.

In a gas concentration measurement operation, the thermistor Rd1 is heated to, for example, around 300° C. (an example of a first temperature range) by the heater MH1, and the thermistor Rd2 is heated to, for example, around 150° C. (an example of a second temperature range) by the heater MH2. The first temperature range is a predetermined temperature range included in a range, for example, between 250° C. and 450° C. inclusive and is, for example, a temperature range around 300° C. The second temperature range is a predetermined temperature range included in a range, for example, between 100° C. and 230° C. inclusive and is, for example, a temperature range around 150° C. The “temperature range” in the present specification has a temperature width equal to or less than 1° C., for example. For example, a temperature range around 150° C. may be 149.5° C. or more and 150.5° C. or less. Further, for example, a temperature range around 300° C. may be 299.5° C. or more and 300.5° C. or less. The thermistor Rd1 is designed to have a predetermined resistance value when being heated to 300° C., while the thermistor Rd2 is designed to have a predetermined resistance value when being heated to 150° C. The first temperature range (in this example, a temperature range around 300° C.) differs from and is higher than the second temperature range (in this example, a temperature range around 150° C.).

When CO₂ gas is present in measurement atmosphere in a state where the thermistor Rd2 as the detection temperature-sensitive element is heated to around 150° C., the heat dissipation characteristics of the thermistor Rd2 change according to the concentration of the CO₂ gas. This change appears as a change in the temperature of the thermistor Rd2, i.e., a change in the resistance value thereof. CO₂ gas is lower in heat dissipation than air, so that the temperature of the thermistor Rd2 rises as the concentration of CO₂ gas increases. Here, assume that heating is performed such that the temperature of the thermistor Rd2 becomes 150° C. when CO₂ gas concentration in measurement atmosphere is, for example, zero. In this case, if CO₂ gas is present in measurement atmosphere, the temperature of the thermistor Rd2 increases with an increase in the CO₂ gas concentration and exceeds 150° C. As a result, the resistance value of the thermistor Rd2 lowers as the CO₂ gas concentration in measurement atmosphere increases.

On the other hand, even when CO₂ gas is present in measurement atmosphere in a state where the thermistor Rd1 as the reference temperature-sensitive element is heated to around 300° C., the heat dissipation characteristics of the thermistor Rd1 hardly change irrespective of the concentration of the CO₂ gas, and the temperature thereof also hardly changes. Accordingly, a CO₂ gas concentration-dependent change in the resistance value of the thermistor Rd1 heated to around 300° C. is sufficiently smaller than a CO₂ gas concentration-dependent change in the resistance value of the thermistor Rd2 heated to around 150° C. There may be almost no CO₂ gas concentration-dependent change in the resistance value of the thermistor Rd1 heated to around 300° C. As a result, when the thermistors Rd2 and Rd1 are heated to around 150° C. and around 300° C., respectively (when heating is performed such that temperatures of the thermistors Rd2 and Rd1 become 150° C. and 300° C. when CO₂ gas concentration in measurement atmosphere is, for example, zero), the detection signal Vgas1 corresponding to the concentration of CO₂ gas in measurement atmosphere appears at the node N1 between the thermistors Rd1 and Rd2. On the other hand, even when another gas that brings about no significant difference between the heat dissipation characteristics of the thermistor Rd2 exhibited when it is heated to around 150° C. and those of the thermistor Rd1 exhibited when it is heated to around 300° C. is contained in measurement atmosphere, the concentration of this gas has little influence on the detection signal Vgas1. This allows the sensor part 10 to selectively detect the concentration of CO₂ gas.

The sensor part 20 has the same circuit configuration as that of the sensor part 10. That is, the sensor part 20 includes thermistors Rd4 and Rd3 connected in series in this order between the power supply Vcc and the ground GND and heaters MH3 and MH4 for heating the thermistors Rd3 and Rd4, respectively. A detection signal Vgas2 of the sensor part 20 appears at a node N2 between the thermistors Rd3 and Rd4. The thermistor Rd4 is a temperature-sensitive element for detection and may have the same configuration as that of the thermistor Rd2 included in the sensor part 10. The thermistor Rd3 is a temperature-sensitive element for reference and may have the same configuration as that of the thermistor Rd1 included in the sensor part 10. The thermistors Rd3 and Rd4 are each a resistor whose resistance value varies with temperature. In the gas concentration measurement operation, the thermistor Rd3 is heated to, for example, around 300° C. (an example of a first temperature range) by the heater MH3, and the thermistor Rd4 is heated to, for example, around 150° C. (an example of a second temperature range) by the heater MH4. Like the thermistor Rd1 included in the sensor part 10, the thermistor Rd3 is designed to have a predetermined resistance value when being heated to 300° C. Further, like the thermistor Rd2 included in the sensor part 10, the thermistor Rd4 is designed to have a predetermined resistance value when being heated to 150° C.

The temperature sensor 30 includes a thermistor Rd5 and a fixed resistor R1 which are connected in series between the power supply Vcc and the ground GND. A temperature detection signal Vtemp of the temperature sensor 30 appears at a node N3 between the thermistor Rd5 and the fixed resistor R1. The temperature sensor 30 detects environmental temperature. The environmental temperature is a temperature in measurement atmosphere. The temperature sensor 30 may be designed so as not to be affected or so as to be hardly affected by heating by, for example, the heaters MH1, MH2, MH3, and MH4.

The signal processing circuit 40 includes differential amplifiers 41 and 42, a buffer 43, an AD converter (ADC) 44, a DA converter (DAC) 45, and a control circuit 46.

The differential amplifier 41 compares the detection signal Vgas1 and a reference signal Vref to generate an amplified signal Vamp1 which is a signal obtained by amplifying a difference (=Vgas1−Vref) in level between the detection signal Vgas1 and the reference signal Vref. The differential amplifier 42 compares the detection signal Vgas2 and the reference signal Vref to generate an amplified signal Vamp2 which is a signal obtained by amplifying a difference (=Vgas2−Vref) in level between the detection signal Vgas2 and the reference signal Vref. The buffer 43 buffers the temperature detection signal Vtemp to generate an amplified signal Vamp3. The amplified signals Vamp1 to Vamp3 are input to the AD converter 44. The AD converter 44 A-D converts the amplified signals Vamp1 to Vamp3 to generate digital values and supplies them to the control circuit 46.

The control circuit 46 calculates the concentration of CO₂ gas which is a gas to be detected based on the A-D converted amplified signal Vamp1 or Vamp2 and generates an output signal Vout indicating the CO₂ gas concentration. The control circuit 46 calculates the CO₂ gas concentration using a calculation formula set therein. Further, the control circuit 46 supplies digital values of various control parameters to the DA converter 45. The DA converter 45 D-A converts the digital values of the various control parameters to generate heater voltages Vmh1 to Vmh4 and the reference signal Vref. The heater voltages Vmh1 to Vmh4 are applied to the heaters MH1 to MH4, respectively, whereby the thermistors Rd1 to Rd4 are heated. The reference signal Vref is supplied to the differential amplifiers 41 and 42.

The control circuit 46 corrects the heater voltages Vmh1 to Vmh4 in accordance with the A-D converted amplified signal Vamp3. The control circuit 46 corrects the heater voltages Vmh1 to Vmh4 such that the temperatures of both the thermistors Rd2 and Rd4 become 150° C. and the temperatures of both the thermistors Rd1 and Rd3 become 300° C. irrespective of the environmental temperature when the CO₂ gas concentration in measuring temperature is, for example, zero.

The following describes the operation of the gas sensor 100 according to the present embodiment.

The gas sensor 100 executes generation of both the output signal Vout using the detection signal Vgas1 of the sensor part 10 and the output signal Vout using the detection signal Vgas2 of the sensor part 20. The signal processing circuit 40 controls the sensor part 10 so as to suppress a temporal change, while it controls the sensor part 20 so as to correctly detect the concentration of a gas to be detected even when the concentration of a gas to be detected significantly varies in a short period of time.

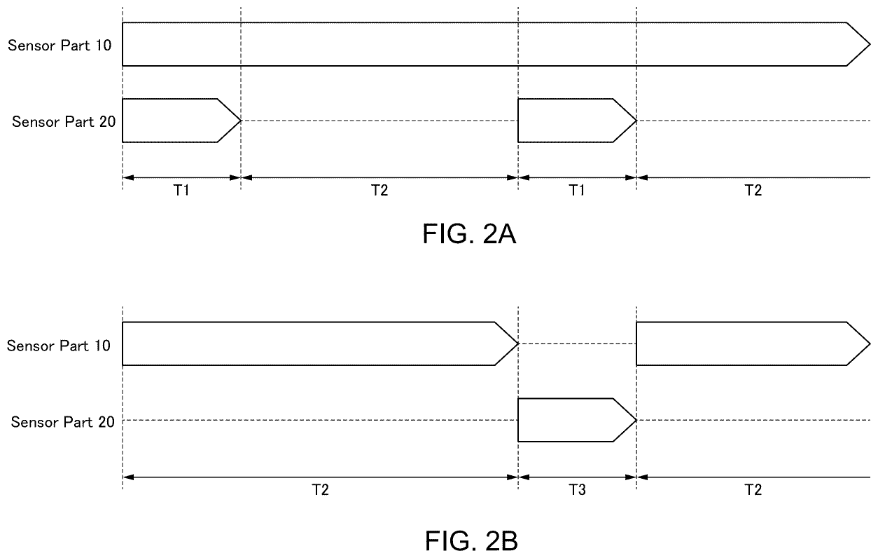

FIGS. 2A and 2B are schematic views for explaining an example of the gas concentration measurement operation of the sensor parts 10 and 20.

The example illustrated in FIG. 2A is as follows: in an operation period T1, the gas concentration measurement operation of the sensor part 10 and the gas concentration measurement operation of the sensor part 20 are executed in parallel; in an operation period T2, the gas concentration measurement operation of the sensor part 10 is executed, while the gas concentration measurement operation of the sensor part 20 is stopped. The operation period T1 and operation period T2 are distinct and do not overlap each other. The operation period T1 may be shorter than the operation period T2.

The example illustrated in FIG. 2B is as follows: in the operation period T2, the gas concentration measurement operation of the sensor part 10 is executed, while the gas concentration measurement operation of the sensor part 20 is stopped; in an operation period T3, the gas concentration measurement operation of the sensor part 20 is executed, while the gas concentration measurement operation of the sensor part 10 is stopped. The operation period T3 and operation period T2 are distinct and do not overlap each other. The operation period T3 may be shorter than the operation period T2.

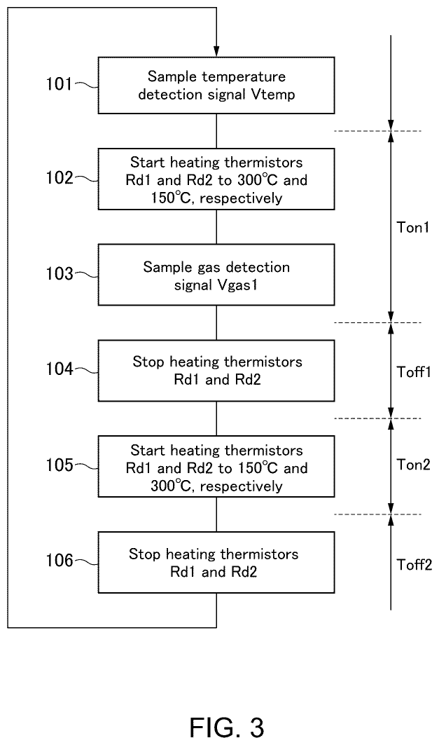

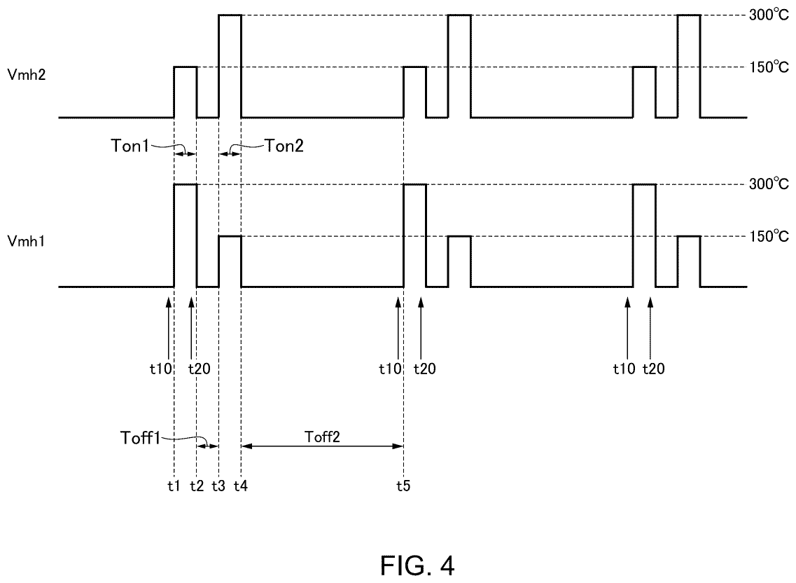

FIG. 3 is a flowchart for explaining the operation of the sensor part 10, and FIG. 4 is a timing chart for explaining the operation of the sensor part 10.

When performing the gas concentration measurement operation using the sensor part 10, the signal processing circuit 40 included in the gas sensor 100 samples the temperature detection signal Vtemp and calculates the environmental temperature (step 101). The temperature detection signal Vtemp is sampled at a timing t10 illustrated in FIG. 4. The timing timing immediately before a timing t1 at which the heaters MH1 and MH2 start heating the thermistors Rd1 and Rd2, respectively.

Then, the control circuit 46 included in the signal processing circuit 40 calculates a heater command value based on the environmental temperature and outputs it to the DA converter 45 to start heating the thermistors Rd1 and Rd2 (step 102). The heater command value is converted by the DA converter 45 into heater voltages Vmh1 and Vmh2, which are applied to the heaters MH1 and MH2, respectively. In step 102, the thermistor Rd1 is heated to about 300° C., and the thermistor Rd2 is heated to about 150° C. The heating of the thermistors Rd1 and Rd2 is started at the timing t1 illustrated in FIG. 4 (when the concentration of CO₂ gas in the measurement atmosphere is, for example, zero, the thermistor Rd1 is heated to 300° C., and the thermistor Rd2 is heated to 150° C.).

The thermistors Rd1 and Rd2 are not stable in terms of temperature until a predetermined time has elapsed from the timing t1 at which the heating of them is started, so that a predetermined standby time is required until the detection signal Vgas1 is sampled after the start of heating. The signal processing circuit 40 samples the detection signal Vgas1 at a timing t20 at which predetermined standby time has elapsed (step 103). Subsequently, the signal processing circuit 40 calculates the output signal Vout from the detection signal Vgas1 and outputs the calculated output signal Vout to the outside.

Then, the control circuit 46 resets the heater command value to stop heating the thermistors Rd1 and Rd2 (step 104). The heating of the thermistors Rd1 and Rd2 is stopped at a timing t2 illustrated in FIG. 4. Through the above processing, the gas concentration measurement operation using the sensor part 10 is completed. In the gas concentration measurement operation using the sensor part 10, the time interval from the timing t1 at which the heating of the thermistors Rd1 and Rd2 is started to the timing t2 at which the heating of them is stopped is defined as an ON period Ton1.

After elapse of a predetermined OFF period Toff1 from the timing t2, the control circuit 46 outputs the heater command value calculated based on the environmental temperature to the DA converter 45 to start dummy heating for the thermistors Rd1 and Rd2 (step 105). In step 105, the thermistor Rd1 is heated to about 150° C. (an example of the second temperature range), and the thermistor Rd2 is heated to about 300° C. (an example of the first temperature range). The heating of the thermistors Rd1 and Rd2 is started at a timing t3 illustrated in FIG. 4 (when the concentration of CO₂ gas in the measurement atmosphere is, for example, zero, the thermistor Rd1 is heated to 300° C., and the thermistor Rd2 is heated to 150° C.). Thus, the OFF period Toff1 is defined as the time interval from the timing t2 at which the heating of the thermistors Rd1 and Rd2 is stopped to the timing t3 at which the heating of them is started.

After the elapse of a predetermined ON period Ton2 from the timing t3, the control circuit 46 resets the heater value to stop heating the thermistors Rd1 and Rd2 (step 106). The heating of the thermistors Rd1 and Rd2 is stopped at a timing t4 illustrated in FIG. 4. Thus, the dummy heating operation is completed. In the dummy heating operation, the time interval from the timing t3 at which the heating of the thermistors Rd1 and Rd2 is started to the timing t4 at which the heating of them is stopped is defined as an ON period Ton2.

After the elapse of a predetermined OFF period Toff2 from the timing t4, the control circuit 46 restarts the gas concentration measurement operation. The signal processing circuit 40 samples the temperature detection signal Vtemp and calculates the environmental temperature (step 101), and the control circuit 46 outputs the heater command value calculated based on the environmental temperature, to thereby start heating the thermistors Rd1 and Rd2 (step 102). The heating of the thermistors Rd1 and Rd2 is started at a timing t5 illustrated in FIG. 4. Thus, the OFF period Toff2 is defined as the time interval from the timing t4 at which the heating of the thermistors Rd1 and Rd2 is stopped to the timing t5 at which the heating of the thermistors Rd1 and Rd2 is started again.

By repeatedly executing the above-described operation in a predetermined period, the concentration of a gas to be detected contained in the measurement environment can be detected periodically. In addition, in the ON period Ton1 during which the gas concentration measurement operation is performed, the thermistors Rd1 and Rd2 are heated to about 300° C. and 150° C., respectively, while in the ON period Ton2 during which the dummy heating operation is performed, the thermistors Rd1 and Rd2 are heated to about 150° C. and 300° C., respectively, thus reducing a difference in thermal history between the thermistors Rd1 and Rd2, which suppresses a temporal change of the sensor part 10 due to the thermal history difference. In order to further reduce the thermal history difference, the length of the ON period Ton1 and the length of the ON period Ton2 may be the same.

On the other hand, the lengths of the OFF period Toff1 and OFF period Toff2 need not be the same as each other, and the OFF period Toff2 may be longer than the OFF period Toff1. That is, a next gas concentration measurement operation is performed immediately after the OFF period Toff2, so that by providing a sufficient length for the OFF period Toff2, it is possible to reduce a measurement error due to the influence of remaining heat. The influence of remaining heat appears as the temporal drift of the value of the output signal Vout.

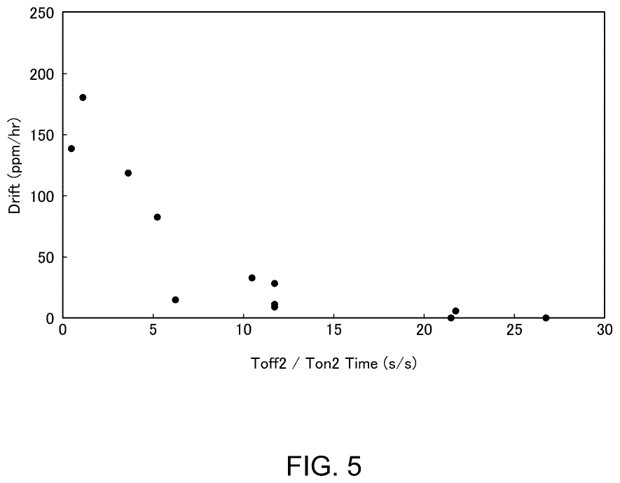

FIG. 5 is a graph illustrating the relationship between the ratio (Toff2/Ton2) of the OFF period Toff2 to the ON period Ton2 and a drift amount per unit time of the measurement result of CO₂ gas concentration obtained from the output signal Vout in a measurement atmosphere where CO₂ gas concentration is controlled constant at 400 ppm.

As can be seen from FIG. 5, the drift amount per unit time becomes smaller as the ratio (Toff2/Ton2) of the OFF period Toff2 to the ON period Ton2 is larger. The drift amount per unit time is substantially saturated when the ratio of the OFF period Toff2 to the ON period Ton2 becomes 10 or more and becomes substantially zero when the ratio of the OFF period Toff2 to the ON period Ton2 is 20 or more. Considering this, in order to sufficiently suppress the drift of the measurement result of CO₂ gas concentration due to the influence of remaining heat, the OFF period Toff2 may be made 10 or more times longer and may be made 20 or more times longer than the ON period Ton2. There is no upper limit to the ratio of the OFF period Toff2 to the ON period Ton2; however, an excessively long OFF period Toff2 prolongs the period with which the output signal Vout can be obtained, so that the length of the OFF period Toff2 may be set according to the purpose.

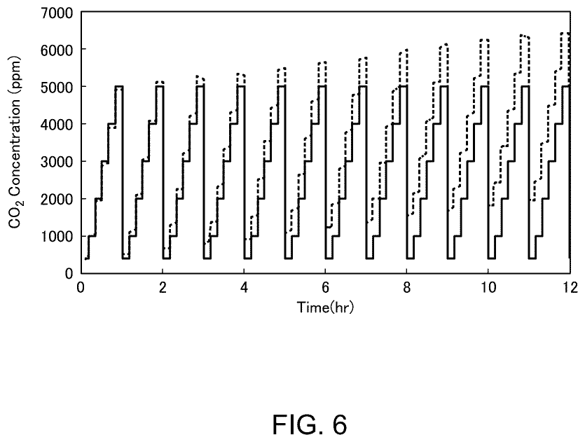

FIG. 6 is a graph illustrating a change in the output signal Vout (measurement result of CO₂ gas concentration obtained from the output signal Vout) in an atmosphere where CO₂ gas concentration is controlled. In this graph, the solid line denotes a case where the ratio (Toff2/Ton2) of the OFF period Toff2 to the ON period Ton2 is set to 21.5, and the dashed line denotes a case where the ratio (Toff2/Ton2) of the OFF period Toff2 to the ON period Ton2 is set to 3.63. CO₂ gas concentration is changed stepwise (1000 ppm, 2000 ppm. 3000 ppm, 4000 ppm, 5000 ppm) with 400 ppm set as a reference value. The ratio (Toff1/Ton1) of the OFF period Toff1 to the ON period Ton1 is set to a fixed value ((Toff1/Ton1)=5).

As can be seen from FIG. 6, when the value of Toff2/Ton2 is 21.5, the output signal OUT indicates an accurate value, while when the value of Toff2/Ton2 is 3.63, the drift occurring in the output signal OUT becomes larger with the passage of time.

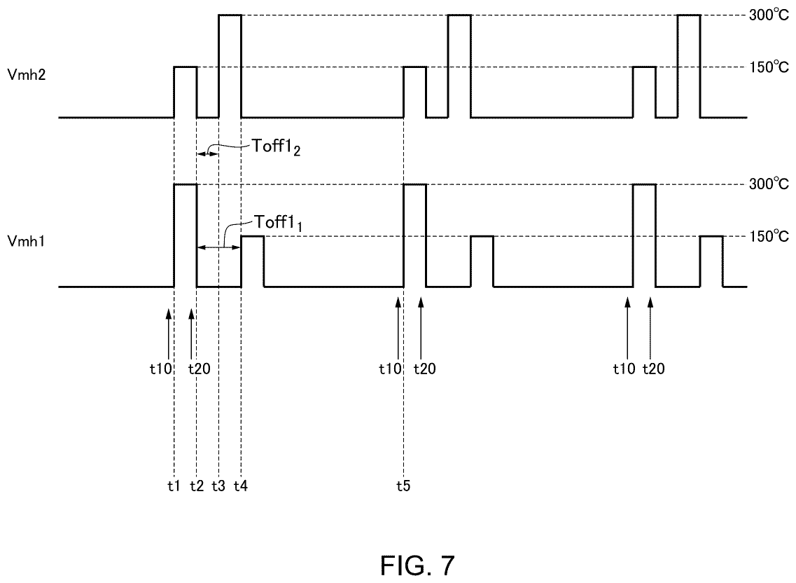

FIG. 7 is a timing chart for explaining the operation of the sensor part 10 according to a modification.

As illustrated in FIG. 7, in the operation of the sensor part 10 according to the modification, the OFF period Toff1₁, which is time interval from the operation of heating t the thermistor Rd1 to around 300° C. (first temperature range) using the heater MH1 in the gas concentration measurement operation to the operation of heating the thermistor Rd1 to around 150° C. (second temperature range) using the heater MH1 in the dummy heating operation, for the thermistor Rd1 is set longer than the OFF period Toff1₂, which is time interval from the operation of heating the thermistor Rd2 to around 150° C. (second temperature range) using the heater MH2 in the gas concentration measurement operation to the operation of heating the thermistor Rd2 to around 300° C. (first temperature range) using the heater MH2 in the dummy heating operation, for the thermistor Rd2. In the example illustrated in FIG. 7, the OFF period Toff1₁ for the thermistor Rd1 ends at the timing t4. This reduces a difference between the temperatures of the thermistors Rd1 and Rd2 at a timing when the dummy heating operation is started, thus making it possible to further reduce a difference in thermal history between the thermistors Rd1 and Rd2. Thus, in the dummy heating operation, the thermistors Rd1 and Rd2 need not be heated at the same time.

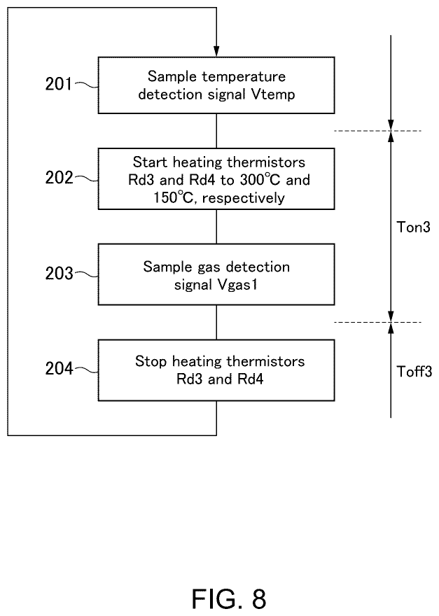

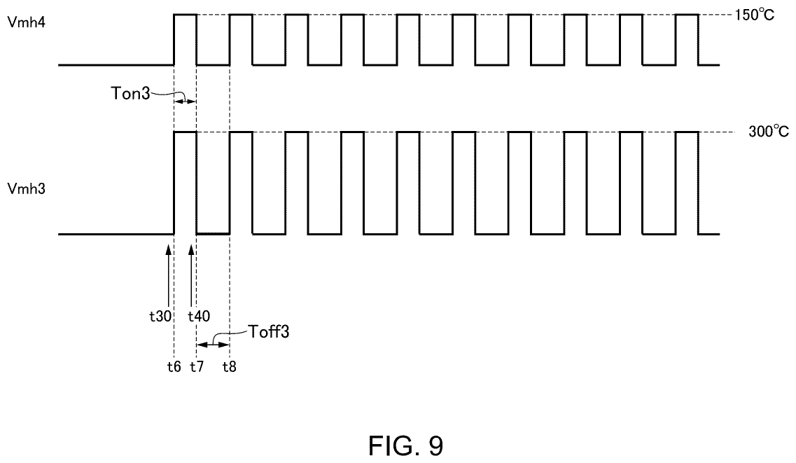

FIG. 8 is a flowchart for explaining the operation of the sensor part 20. FIG. 9 is a timing chart for explaining the operation of the sensor part 20.

When performing the gas concentration measurement operation using the sensor part 20, the signal processing circuit 40 included in the gas sensor 100 samples the temperature detection signal Vtemp and calculates the environmental temperature (step 201). The temperature detection signal Vtemp is sampled at a timing t30 illustrated in FIG. 9. The timing t30 is a timing immediately before a timing t6 at which the heaters MH3 and MH4 start heating the thermistors Rd3 and Rd4, respectively.

Then, the control circuit 46 included in the signal processing circuit 40 calculates a heater command value based on the environmental temperature and outputs it to the DA converter 45 to start heating the thermistors Rd3 and Rd4 (step 202). The heater command value is converted by the DA converter 45 into heater voltages Vmh3 and Vmh4, which are applied to the heaters MH3 and MH4, respectively. In step 202, the thermistor Rd3 is heated to about 300° C., and the thermistor Rd4 is heated to about 150° C. (when the concentration of CO₂ gas in the measurement atmosphere is, for example, zero, the thermistor Rd3 is heated to 300° C., and the thermistor Rd4 is heated to 150° C.). The heating of the thermistors Rd3 and Rd4 is started at the timing t6 illustrated in FIG. 9.

The thermistors Rd3 and Rd4 are not stable in terms of temperature until a predetermined time has elapsed from the timing t6 at which the heating of them is started, so that a predetermined standby time is required until the detection signal Vgas2 is sampled after the start of heating. The signal processing circuit 40 samples the detection signal Vgas2 at a timing t40 at which a predetermined standby time has elapsed (step 203). Subsequently, the signal processing circuit 40 calculates the output signal Vout from the detection signal Vgas2 and outputs the calculated output signal Vout to the outside.

Then, the control circuit 46 resets the heater command value to stop heating the thermistors Rd3 and Rd4 (step 204). The heating of the thermistors Rd3 and Rd4 is stopped at a timing t7 illustrated in FIG. 9. Thus, the gas concentration measurement operation using the sensor part 20 is completed. In the gas concentration measurement operation using the sensor part 20, the time interval from the timing t6 at which the heating of the thermistors Rd3 and Rd4 is started to the timing t7 at which the heating of them is stopped is defined as an ON period Ton3. The ON period Ton3 may be the same in length as the ON period Ton1 set in the sensor part 10.

After the elapse of a predetermined OFF period Toff3 from the timing t7, the control circuit 46 restarts the gas concentration measurement operation. The signal processing circuit 40 samples the temperature detection signal Vtemp and calculates the environmental temperature (step 201), and the control circuit 46 outputs the heater command value calculated based on the environmental temperature, to thereby start heating the thermistors Rd3 and Rd4 (step 202). The heating of the thermistors Rd3 and Rd4 is started at a timing t8 illustrated in FIG. 9. Thus, the OFF period Toff3 is defined as the time interval from the timing t7 at which the heating of the thermistors Rd3 and Rd4 is stopped to the timing t8 at which the heating of them is started again. The OFF period Toff3 may be shorter in length than the OFF period Toff2 set in the sensor part 10. The OFF period Toff3 may be the same as or shorter than the OFF period Toff1 set in the sensor part 10.

By repeatedly executing the above-described operation in a predetermined period of time, the concentration of a gas to be detected contained in the measurement environment can be detected periodically.

As described above, in the sensor part 10, the gas concentration measurement operation and dummy heating operation are alternately executed; while in the sensor part 20, the gas concentration measurement operation is executed continually with the OFF period Toff3 interposed therebetween without interposition of the dummy heating operation (operation of heating the thermistor Rd3 to around 150° C. (second temperature range) using the heater MH3 for a predetermined period of time and heating the thermistor Rd4 to around 300° C. (first temperature range) using the heater MH4 for a predetermined period of time).

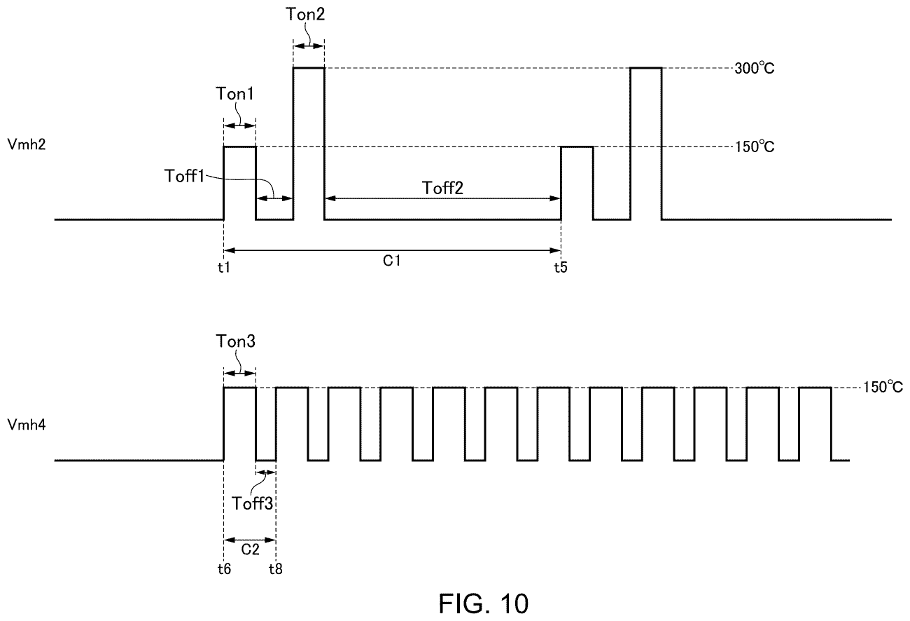

FIG. 10 is a timing chart for explaining the operations of the sensor parts 10 and 20 in the operation period T1 illustrated in FIG. 2.

As illustrated in FIG. 10, in the operation period T1, the gas concentration measurement operation in the sensor part 20 is executed more frequently than that in the sensor part 10. An execution cycle C1 of the gas concentration measurement operation in the sensor part 10 is defined by the time interval from a time point t1 to a time point t5. An execution cycle C2 of the gas concentration measurement operation in the sensor part 20 is defined by the time interval from a time point t6 to a time point t8. The execution cycle C2 is shorter than the execution cycle C1 and, accordingly, the execution frequency per unit time of gas concentration the measurement operation in the sensor part 20 is higher than the execution frequency per unit time of the gas concentration measurement operation in the sensor part 10. The reason that the execution cycle C2 can be shortened is because in the sensor part 20, no dummy heating operation is performed while the gas concentration measurement operation is executed continually. Further, in the operation period T3 illustrated in FIG. 2B, the operation of the sensor part 10 is stopped and, naturally, the gas concentration measurement operation in the sensor part 20 is executed more frequently than that in the sensor part 10, so that the execution frequency per unit time of the gas concentration measurement operation in the sensor part 20 is higher than the execution frequency per unit time of the gas concentration measurement operation in the sensor part 10.

Thus, in the operation period T1, the sensor part 10 is used to achieve stable gas concentration measurement operation with less temporal change, and the high-frequency gas concentration measurement operation using the sensor part 20 allows the output signal Vout to follow a concentration variation even when the concentration of CO₂ gas significantly varies in a short time. Further, in the operation period T2, the sensor part 10 is used to achieve stable gas concentration measurement operation with less temporal change, and in the operation period T3, the high-frequency gas concentration measurement operation using the sensor part 20 allows the output signal Vout to follow a concentration variation even when the concentration of CO₂ gas significantly varies in a short period of time.

The gas concentration measurement operation using the sensor part 10 and that using the sensor part 20 may be performed asynchronously or at different times. For example, when the timings of the gas concentration measurement operations of the sensor parts 10 and 20 are made to differ from each other such that a time point t20 illustrated in FIG. 4 and a time point t40 illustrated in FIG. 9 do not overlap each other, the amplified signals Vamp1 and Vamp2 are not input to the AD converter 44 at the same time.

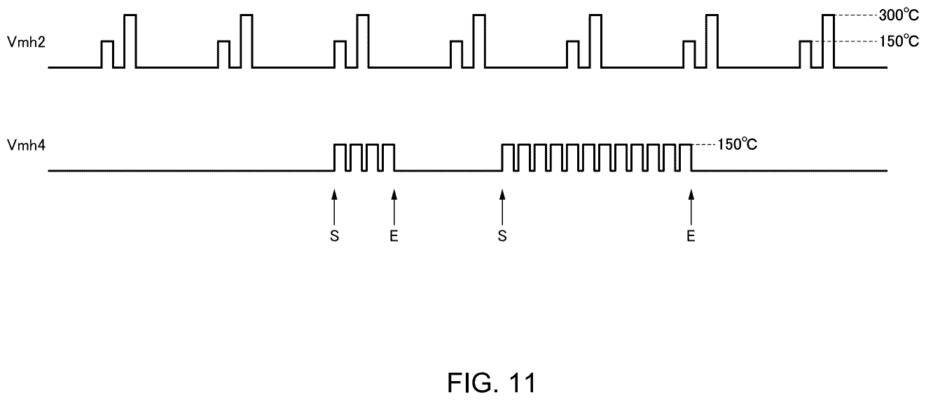

As described above using FIG. 2, the gas concentration measurement operation using the sensor part 20 need not be performed constantly but may be performed intermittently. For example, as illustrated in FIG. 11, a configuration may be adopted, in which the gas concentration measurement operation using the sensor part 20 is started in response to a start signal S supplied from an external device and stopped in response to a stop signal E supplied from the external device. The start signal S and stop signal E are supplied to the control circuit 46, as illustrated in FIG. 1. Alternatively, a timer or the like may be provided in the signal processing circuit 40 so as to automatically start the gas concentration measurement operation using the sensor part 20 at a predetermined time point and to automatically end the gas concentration measurement operation using the sensor part 20 after the elapse of a predetermined period of time.

As described above, for the sensor part 20, no dummy heating operation is performed while the gas concentration measurement operation is executed continually, so that a difference in thermal history occurs between the thermistors Rd3 and Rd4, with the result that the sensor part 20 is subjected to temporal change. For example, when the cumulative execution time of the gas concentration measurement operation using the sensor part 20 in the operation periods T1 and T2 is controlled to be shorter than the cumulative execution time of the gas concentration measurement operation using the sensor part 10, the temporal change of the sensor part 20 is suppressed. In the operation period T2, even though the gas concentration measurement operation using the sensor part 20 is stopped, the gas concentration measurement operation and dummy heating operation using the sensor part 10 are periodically alternately executed, so that the output signal Vout can be obtained periodically. To suppress the temporal change of the sensor part 20, the operation period T1 or T3 may be made shorter than the operation period T2 illustrated in FIG. 2.

Alternatively, in the operation period T1, the value of the output signal Vout calculated from the detection signal Vgas1 and the value of the output signal Vout calculated from the detection signal Vgas2 are compared with each other, and when an unignorable difference occurs therebetween as a result of the comparison, it may be determined that the short execution cycle C2 has caused, in the sensor part 20, a drift of the output signal Vout due to remaining heat, and the operation period T2 may be prolonged so as to make the difference therebetween ignorable. Alternatively, when the temporal change of the sensor part 20 can be determined to be large due to an increase in the difference in thermal history between the thermistors Rd3 and Rd4, the gas concentration measurement operation using the sensor part 20 may be prohibited. Further alternatively, the drift component or temporal change component may be removed by adding a correction to a calculation formula for calculating the output signal Vout from the detection signal Vgas2 based on the difference between the value of the output signal Vout calculated from the detection signal Vgas1 and the value of the output signal Vout calculated from the detection signal Vgas2.

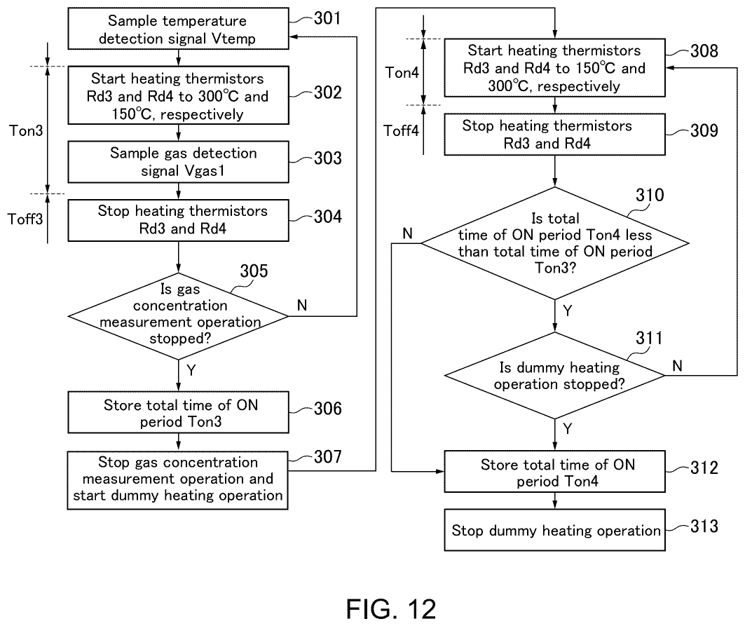

FIG. 12 is a flowchart for explaining the operation of the sensor part 20 according to a modification.

In the modification illustrated in FIG. 12, the sensor part 20 performs not only the gas concentration measurement operation but also the dummy heating operation. When performing the gas concentration measurement operation using the sensor part 20, the signal processing circuit 40 included in the gas sensor 100 samples the temperature detection signal Vtemp and calculates the environmental temperature (step 301). Then, the control circuit 46 included in the signal processing circuit 40 calculates a heater command value based on the environmental temperature and outputs it to the DA converter 45 to start heating the thermistors Rd3 and Rd4 (step 302). The heater command value is converted by the DA converter 45 into heater voltages Vmh3 and Vmh4, which are applied to the heaters MH3 and MH4, respectively. In step 302, the thermistor Rd3 is heated to about 300° C., and the thermistor Rd4 is heated to about 150° C. (when the concentration of CO₂ gas in the measurement atmosphere is, for example, zero, the thermistor Rd3 is heated to 300° C., and the thermistor Rd4 is heated to 150° C.).

The signal processing circuit 40 samples the detection signal Vgas2 at a timing at which a predetermined standby time has elapsed (step 303). Subsequently, the signal processing circuit 40 calculates the output signal Vout from the detection signal Vgas2 and outputs the calculated output signal Vout to the outside. Then, the control circuit 46 resets the heater command value to stop heating the thermistors Rd3 and Rd4 (step 304). In the gas concentration measurement operation using the sensor part 20, the time interval from when the heating of the thermistors Rd3 and Rd4 is started in step 302 to when the heating of them is stopped in step 304 is defined as an ON period Ton3.

Then, the control circuit 46 determines whether to stop the gas concentration measurement operation using the sensor part 20 (step 305). This determination may be made based on whether the stop signal E has been input. When determining not to stop the gas concentration measurement operation using the sensor part 20, the control circuit 46 returns to step 301 to calculate the environmental temperature and starts heating the thermistors Rd3 and Rd4 again. In the gas concentration measurement operation using the sensor part 20, the time interval from when the heating of the thermistors Rd3 and Rd4 is stopped to when the heating of them is started is defined as the OFF period Toff3. On the other hand, when determining to stop the gas concentration measurement operation using the sensor part 20, the control circuit 46 stores the total heating time (total time of the ON period Ton3) for the thermistors Rd3 and Rd4 in the gas concentration measurement operation using the sensor part 20 (step 306) and starts the dummy heating operation for the sensor part 20 after stopping the gas concentration measurement operation using the sensor part 20 (step 307).

In the dummy heating operation for the sensor part 20, the heating of the thermistors Rd3 and Rd4 is started (step 308). In this dummy heating operation, the thermistors Rd3 and Rd4 are heated to about 150° C. and about 300° C., respectively. Subsequently, the control circuit 46 stops heating the thermistors Rd3 and Rd4 (step 309). In the dummy heating operation for the sensor part 20, the time interval from when the heating of the thermistors Rd3 and Rd4 is started in step 308 to when the heating of them is stopped in step 309 is defined as an ON period Ton4. The length of the ON period Ton4 may be the same as that of the ON period Ton3.

Then, the control circuit 46 determines whether the total heating time (total time of the ON period Ton4) for the thermistors Rd3 and Rd4 in the dummy heating operation for the sensor part 20 is less than the total heating time (total time of the ON period Ton3) for the thermistors Rd3 and Rd4 in the gas concentration measurement operation using the sensor part 20 (step 310). When determining that the total time of the ON period Ton4 is less than the total time of ON period Ton3, that is, when determining that the total heating time in the dummy heating operation for the sensor part 20 is less than the total heating time in the gas concentration measurement operation using the sensor part 20, the control circuit 46 determines whether to stop the dummy heating operation for the sensor part 20 (step 311). This determination may be made based on whether the start signal S has been input. When determining not to stop the dummy heating operation for the sensor part 20, the control circuit 46 returns to step 308 to restart the dummy heating for the thermistors Rd3 and Rd4. In the dummy heating operation for the sensor part 20, the time interval from when the dummy heating for the thermistors Rd3 and Rd4 is stopped to when the dummy heating therefor is started is defined as an OFF period Toff4.

On the other hand, when determining in step 310 that the total time of the ON period Ton4 is equal to or more than the total time of the ON period Ton3, that is, when determining that the total heating time in the dummy heating operation for the sensor part 20 is equal to or more than the total heating time in the gas concentration measurement operation using the sensor part 20, or when determining in step 311 to stop the dummy heating operation for the sensor part 20, the control circuit 46 stores the total heating time (total time of ON period Ton4) for the thermistors Rd3 and Rd4 in the dummy heating operation for the sensor part 20 (step 312) and stops the dummy heating operation for the sensor part 20 (step 313).

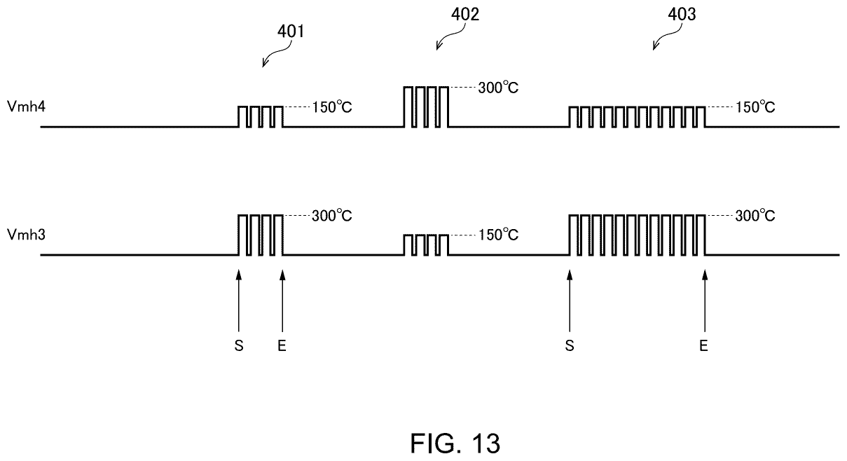

FIG. 13 is a timing chart for explaining an example of the operation of the sensor part 20 according to a modification.

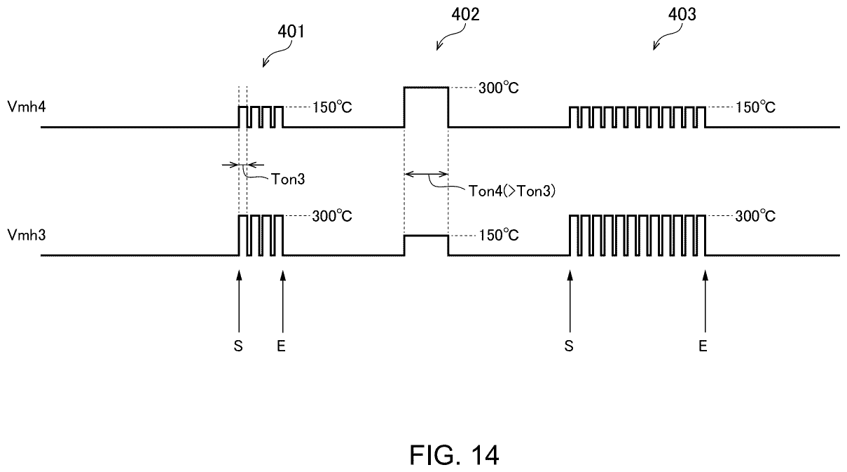

In the example illustrated in FIG. 13, the dummy heating operation for the sensor part 20 is executed in a period 402 existing between a period 401 where the gas concentration measurement operation using the sensor part 20 is executed and a period 403 where the gas concentration measurement operation using the sensor part 20 is executed again. Both the periods 401 and 403 start in response to the start signal S and end in response to the stop signal E. The period 402 may be started at a timing at which a given standby time has elapsed from the end of the period 401. The length of the ON period Ton3 and that of the ON period Ton4 need not be the same and, as in the example of FIG. 14, the length of the ON period Ton4 may be set longer than the length of the ON period Ton3. In this case, step 308 may be continued until the total heating time (total time of ON period Ton4) in the dummy heating operation for the sensor part 20 reaches the total heating time (total time of ON period Ton3) in the gas concentration measurement operation using the sensor part 20.

While some embodiments of the technology according to the present disclosure have been described, the technology according to the present disclosure is not limited to the above embodiments, and various modifications may be made within the scope of the present disclosure, and all such modifications are included in the technology according to the present disclosure.

For example, although a thermistor serving as a resistor is used as a temperature-sensitive element for the sensor parts 10 and 20 in the above embodiment, the present invention is not limited to this. For example, platinum (Pt) or tungsten (W) serving as a resistor may be used as the temperature-sensitive element.

The technology according to the present disclosure includes the following configuration examples, but not limited thereto.

A gas sensor according an aspect of the present disclosure includes: a first sensor part including first and second temperature-sensitive elements connected in series, a first heater configured to heat the first temperature-sensitive element, and a second heater configured to heat the second temperature-sensitive element, wherein the first sensor part is configured to output a first detection signal from a node between the first and second temperature-sensitive elements; a second sensor including third and fourth temperature-sensitive elements connected in series, a third heater configured to heat the third temperature-sensitive element, and a fourth heater configured to heat the fourth temperature-sensitive element, wherein the second sensor part is configured to output a second detection signal from a node between the third and fourth temperature-sensitive elements; and a signal processing circuit configured to control the first and second sensor parts and calculate a concentration of a gas to be detected based on the first and second detection signals. The signal processing circuit is configured to: when controlling the first sensor part, alternately repeatedly execute a first gas concentration measurement operation of heating the first temperature-sensitive element to a first temperature range using the first heater and heating the second temperature-sensitive element to a second temperature range using the second heater and a first dummy heating operation of heating the first temperature-sensitive element to the second temperature range using the first heater and heating the second temperature-sensitive element to the first temperature range using the second heater; and when controlling the second sensor part, repeatedly execute a second gas concentration measurement operation of heating the third temperature-sensitive element to the first temperature range using the third heater and heating the fourth temperature-sensitive element to the second temperature range using the fourth heater without executing an operation of heating the third temperature-sensitive element to the second temperature range using the third heater and heating the fourth temperature-sensitive element to the first temperature range using the fourth heater. An execution frequency of the second gas concentration measurement operation is higher than an execution frequency of the first gas concentration measurement operation in a first operation period. Thus, a stable gas concentration measurement with less temporal change can be performed using the first sensor part, and a high-frequency gas concentration measurement can be performed using the second senor part.

In the above gas sensor, in a second operation period, the signal processing circuit may be configured to execute the first gas concentration measurement operation and the first dummy heating operation and stop the second gas concentration measurement operation. This can suppress the temporal change of the second sensor part.

In the above gas sensor, in the first and second operation periods, the signal processing circuit may be configured to periodically execute the first gas concentration measurement operation and the first dummy heating operation. This allows the concentration of a gas to be detected to be periodically obtained.

In the above gas sensor, a cumulative execution time of the second gas concentration measurement operation in the first and second operation periods may be shorter than a cumulative execution time of the first gas concentration measurement operation in the first and second operation periods. This can suppress the temporal change of the second sensor part.

In the above gas sensor, in the second operation period, the signal processing circuit may be configured to execute a second dummy heating operation of heating the third temperature-sensitive element to the second temperature range using the third heater and heating the fourth temperature-sensitive element to the first temperature range using the fourth heater. This can suppress the temporal change of the second sensor part due to a difference in thermal history between the third and fourth temperature-sensitive elements.

In the above gas sensor, the first temperature range is higher in temperature than the second temperature range, and a time interval from an operation of heating the first temperature-sensitive element to the first temperature range using the first heater in the first gas concentration measurement operation to an operation of heating the first temperature-sensitive element to the second temperature range using the first heater in the first dummy heating operation may be longer than a time interval from an operation of heating the second temperature-sensitive element to the second temperature range using the second heater in the first gas concentration measurement operation to an operation of heating the second temperature-sensitive element to the first temperature range using the second heater in the first dummy heating operation. This can reduce a difference in thermal history between the first and second temperature-sensitive elements.

In the above gas sensor, a time interval from the first dummy heating operation to the first gas concentration measurement operation may be 10 or more times longer than the execution time of the first dummy heating operation. This can reduce a measurement error of the first sensor part due to remaining heat.

What is claimed is:

1. A gas sensor comprising:
a first sensor part including first and second temperature-sensitive elements connected in series, a first heater configured to heat the first temperature-sensitive element, and a second heater configured to heat the second temperature-sensitive element, wherein the first sensor part is configured to output a first detection signal from a node between the first and second temperature-sensitive elements;
a second sensor part including third and fourth temperature-sensitive elements connected in series, a third heater configured to heat the third temperature-sensitive element, and a fourth heater configured to heat the fourth temperature-sensitive element, wherein the second sensor part is configured to output a second detection signal from a node between the third and fourth temperature-sensitive elements; and
a signal processing circuit configured to control the first and second sensor parts and calculate a concentration of a gas to be detected based on the first and second detection signals,
wherein the signal processing circuit is configured to:
when controlling the first sensor part, alternately repeatedly execute a first gas concentration measurement operation of heating the first temperature-sensitive element to a first temperature range using the first heater and heating the second temperature-sensitive element to a second temperature range using the second heater and a first dummy heating operation of heating the first temperature-sensitive element to the second temperature range using the first heater and heating the second temperature-sensitive element to the first temperature range using the second heater; and
when controlling the second sensor part, repeatedly execute a second gas concentration measurement operation of heating the third temperature-sensitive element to the first temperature range using the third heater and heating the fourth temperature-sensitive element to the second temperature range using the fourth heater without executing an operation of heating the third temperature-sensitive element to the second temperature range using the third heater and heating the fourth temperature-sensitive element to the first temperature range using the fourth heater, and
wherein an execution frequency of the second gas concentration measurement is higher than an execution frequency of the first gas concentration measurement operation in a first operation period.

2. The gas sensor as claimed in claim 1, wherein, in a second operation period, the signal processing circuit is configured to execute the first gas concentration measurement operation and the first dummy heating operation and stop the second gas concentration measurement operation.

3. The gas sensor as claimed in claim 2, wherein, in first and second operation periods, the signal the processing circuit is configured to periodically execute the first gas concentration measurement operation and the first dummy heating operation.

4. The gas sensor as claimed in claim 2, wherein a cumulative execution time of the second gas concentration measurement operation in the first and second operation periods is shorter than a cumulative execution time of the first gas concentration measurement operation in the first and second operation periods.

5. The gas sensor as claimed in claim 2, wherein, in the second operation period, the signal processing circuit is configured to execute a second dummy heating operation of heating the third temperature-sensitive element to the second temperature range using the third heater and heating the fourth temperature-sensitive element to the first temperature range using the fourth heater.

6. The gas sensor as claimed in claim 1,
wherein the first temperature range is higher in temperature than the second temperature range, and
wherein a time interval from an operation of heating the first temperature-sensitive element to the first temperature range using the first heater in the first gas concentration measurement operation to an operation of heating the first temperature-sensitive element to the second temperature range using the first heater in the first dummy heating operation is longer than a time interval from an operation of heating the second temperature-sensitive element to the second temperature range using the second heater in the first gas concentration measurement operation to an operation of heating the second temperature-sensitive element to the first temperature range using the second heater in the first dummy heating operation.

7. The gas sensor as claimed in claim 1, wherein a time interval from the first dummy heating operation to the first gas concentration measurement operation is 10 or more times longer than an execution time of the first dummy heating operation.
